(19) United States
(12) Patent Application Publication
(10) Pub. No.: US 2010/0070984 A1
(43) Pub. Date: Mar. 18, 2010

(54) Optical Disk Drive

(75) Inventor: Chun-Lung Ho, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PHILIPS & LITE-ON DIGITAL SOLUTIONS CORPORATION, Taipei City (TW)

(21) Appl. No.: 12/368,529

(22) Filed: Feb. 10, 2009

(30) Foreign Application Priority Data
Sep. 18, 2008 (CN) 200810149498.2

(51) Int. Cl. G11B 33/00

(52) U.S. Cl. 720/600; G9B/7.098

(57) ABSTRACT

An optical disk drive for preventing the splashed oil is provided. The optical disk drive comprises an optical pickup for reading an optical disk; a transmission apparatus and a stepping motor. The transmission apparatus comprises a rack, a connecting element and a connecting base. The connecting element connects the rack with the connecting base and the connecting base is connected to the optical pickup. The stepping motor is connected to a lead screw and the lead screw is meshed with the rack for moving the optical pickup. Lubricating oil is added between the rack and the lead screw. The transmission apparatus further comprises a blocking plate connected to the connecting element and the blocking plate is extended above the lead screw for blocking the splashed oil.

### FIELD OF THE INVENTION

The present invention relates to an optical disk drive and more particularly to an optical disk drive for preventing splashed oil.

### BACKGROUND OF THE INVENTION

With increasing applications of personal computers and multimedia techniques, the data storage media with high data storage density are now rapidly gaining in popularity. Optical discs such as compact discs (CDs), video compact discs (VCDs) and digital versatile disc (DVDs) are widely employed to store considerable digital data due to features of low cost, high capacity and portability. Accordingly, optical disc drives become essential components for reading data from optical discs.

FIG. 1 and FIG. 2 schematically illustrate an internal mechanism of conventional optical disc drive. For clarification and brevity, some components are not shown in FIGS. 1 and 2. The conventional optical disc drive principally comprises a spindle motor 4 for rotating an optical disk and a traverse-chassis 1. Two guide rods 2 are disposed on the traverse-chassis 1 for supporting an optical pickup 5. In addition, the optical pickup 5 is slidable on the guide rods 2 and is moved along the radial direction of the optical disk by a stepping motor 3. The optical pickup 5 is used to read and write data on the optical disk.

As shown in FIG. 2, it depicts the bottom view of the mechanism in FIG. 1. The stepping motor 3 is connected to a lead screw 6 and the optical pickup 5 is connected to a transmission apparatus 7. The lead screw 6 is further connected to the transmission apparatus 7. When the stepping motor 3 is rotated, the lead screw 6 moves the transmission apparatus 7 and then the optical pickup 5 is moved on the guide rods 2. The transmission apparatus 7 is depicted in FIG. 3. The transmission apparatus 7 comprises a rack 71 meshed with the lead screw 6, a connecting base 72 connected to the optical pickup 5 and a connecting element 73 connected the rack 71 with the connecting base 72. The connecting base 72 is connected to the optical pickup 5 by a screw. So when the lead screw 6 rotates, the rack 71 meshed with the lead screw 6 is moved. The connecting base 72 connected to the rack 71 via the connecting element 73 is moved to drive the optical pickup 5. Besides, the connecting element 73 is an elastic element. When the optical disk drive is hit, the rack 71 is still meshed with the lead screw 6 via the elasticity of the connecting element 73. And the optical disk drive is still workable after hit.

Generally, the lubricating oil is added between the rack 71 and the lead screw 6 to increase the transmission efficiency and working reliability. If the amount of the lubricating oil is not enough, the rack 71 and the lead screw 6 are easily jammed. The resistance force between the rack 71 and the lead screw 6 is increased. To drive the lead screw 6, the control chip for controlling the stepping motor 3 continues sending the driving current to the stepping motor 3. And then the temperature of the control chip is increased so that the control chip can not accurately control the stepping motor due to the high temperature. Therefore, the abrasion of the mechanism is increased due to the insufficient lubricating oil. On the contrary, when the lubricating oil is too much, the lubricating oil may be splashed to the optical disk by the rotating lead screw 6. The optical disk drive can not read/write the optical disk normally because of the contaminated optical disk. As a result, the drive manufacture needs to buy a more accurate oil injector for controlling the amount of the lubricating oil.

However, the accurate oil injector increases the fabricating cost and the price of the optical disk drive. Therefore, there is a need of providing an improved optical disk drive to obviate the drawbacks described above.

### SUMMARY OF THE INVENTION

The present invention provides an optical disk drive for preventing the splashed oil.

In accordance with an aspect of the present invention, there is provided an optical disk drive. The optical disk drive comprises an optical pickup for reading an optical disk, a transmission apparatus and a stepping motor. The transmission apparatus comprises a rack, a connecting element and a connecting base. The connecting element connects the rack with the connecting base and the connecting base is connected to the optical pickup. The stepping motor is connected to a lead screw and the lead screw is meshed with the rack for moving the optical pickup. Lubricating oil is added between the rack and the lead screw. The transmission apparatus further comprises a blocking plate connected to the connecting element and the blocking plate is extended above the lead screw for blocking the splashed oil.

### BRIEF DESCRIPTION OF THE DRAWINGS

The above contents of the present invention will become more readily apparent to those ordinarily skilled in the art after reviewing the following detailed description and accompanying drawings, in which:

FIG. 1 schematically illustrates the internal mechanism of conventional optical disk drive;

FIG. 2 shows the bottom view of the mechanism in FIG. 1

FIG. 3 shows a traditional transmission apparatus.

FIG. 4 shows the internal mechanism of the optical disk drive of the present invention.

FIG. 5 shows a first embodiment of the transmission apparatus.

FIG. 5 shows a second embodiment of the transmission apparatus.

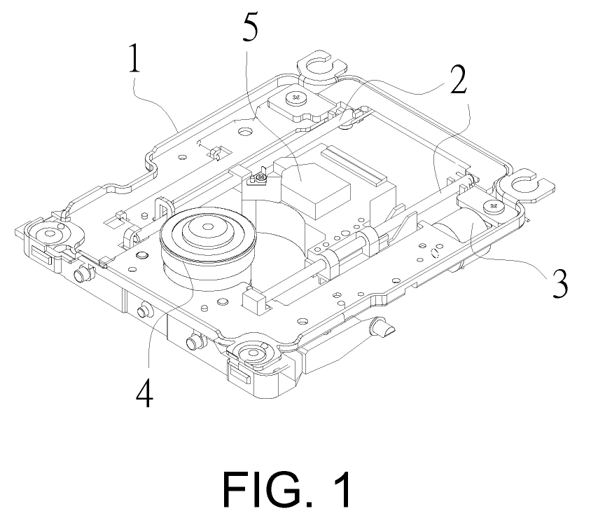

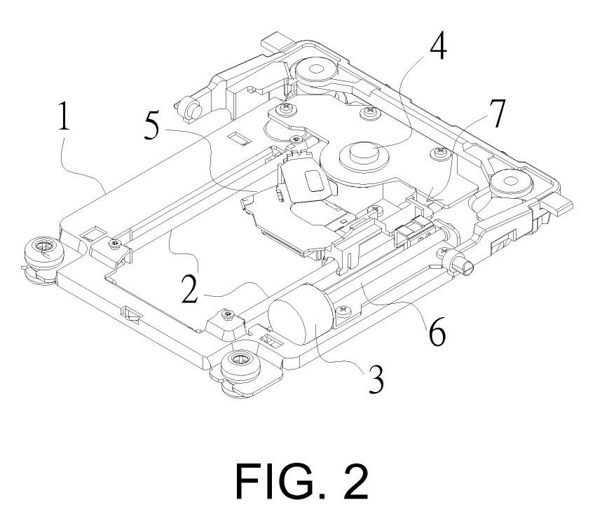

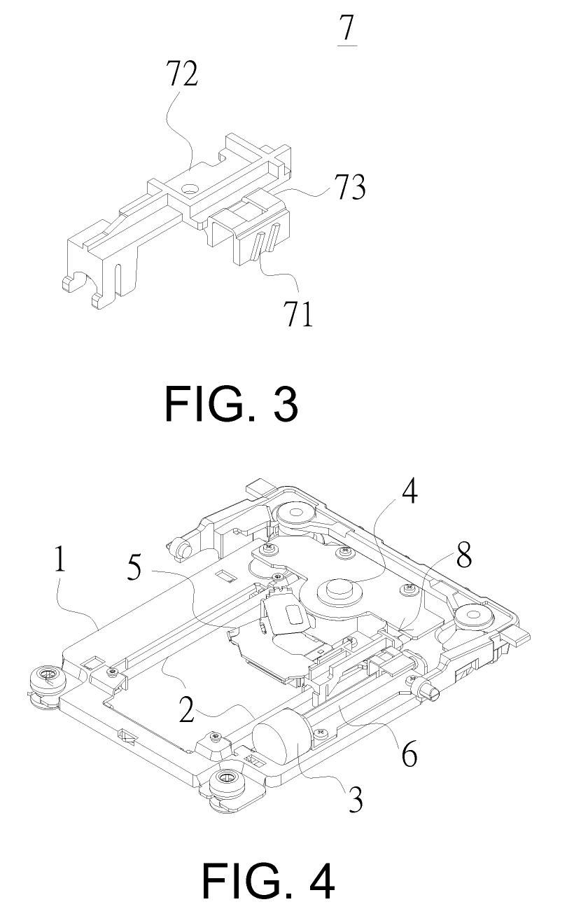

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

FIG. 4 is a schematic diagram illustrating an optical disk drive of the present invention. The optical disk drive of the present invention principally comprises a spindle motor 4 for rotating an optical disk and a traverse-chassis 1. Two guide rods 2 are disposed on the traverse-chassis 1 for supporting a optical pickup 5. The optical pickup 5 is slidable on the guide rods 2 and is moved along the radial direction of the optical disk by a stepping motor 3. The optical pickup 5 is used to read and write data on the optical disk. The stepping motor 3 is connected to a lead screw 6 and the optical pickup 5 is connected to a transmission apparatus 8. The lead screw 6 is further connected to the transmission apparatus 8. So when the stepping motor 3 is rotated, the lead screw 6 moves the transmission apparatus 8 and then the optical pickup 5 is moved on the guide rods 2.

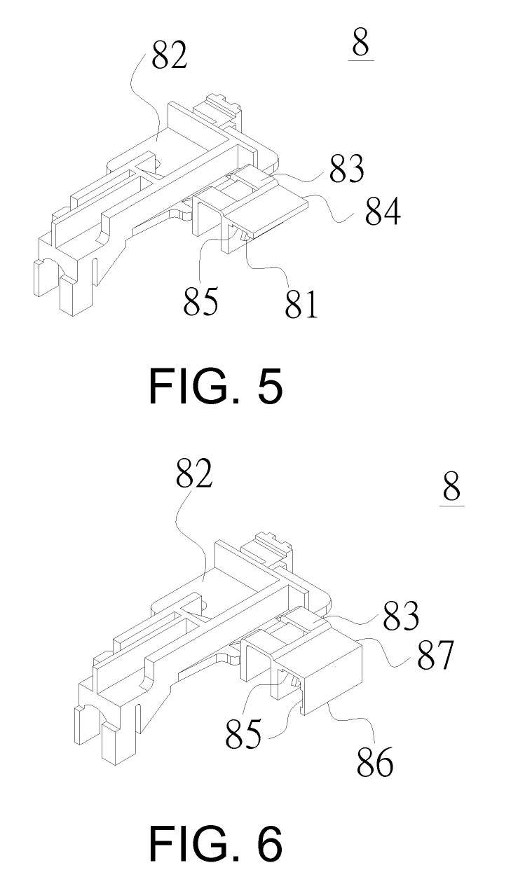

The first embodiment of the transmission apparatus 8 is depicted in FIG. 5. The transmission apparatus 8 comprises a rack 81 meshed with the lead screw 6, a connecting base 82 connected to the optical pickup 5 and a connecting element 83 connected the rack 81 with the connecting base 82. The connecting base 82 is connected to the optical pickup 5 by a screw. So when the stepping motor 3 and the lead screw 6 rotates, the rack 81 meshed with the lead screw 6 is moved. The connecting base 82 connected to the rack 81 via the connecting element 83 is moved to drive the optical pickup 5. Besides, the connecting element 83 is an elastic element. When the optical disk drive is hit, the rack 81 is still meshed with the lead screw 6 via the elasticity of the connecting element 83. And the optical disk drive is still workable after hit. The lubricating oil is added to the rack 81 and the lead screw 6 for lubricating.

The transmission apparatus 8 further comprises a blocking plate 84. The blocking plate 84 is connected to the rack 81 and the connecting element 83. The blocking plate 84 is integrated with the rack 81 and the connecting element 83. The blocking plate 84 is a flat plate and extended above the lead screw 6. The length of the blocking plate 84 is longer than the radius of the lead screw 6. So that the blocking plate 84 covers the lead screw 6. When the lubricating oil is splashed by the rotating lead screw 6, the blocking plate 84 is able to block the splashed oil so that the optical disk is not contaminated by the splashed oil. Moreover, the bottom side of the blocking plate 84 has a trench 85 for storing the splashed oil. When the lubricating oil of the rack 81 and the lead screw 6 is flowed away or dried out, the stored splashed oil in the trench 85 is adequately added to the rack 81 and the lead screw 6. So the rack 81 and the lead screw 6 are not jammed due to the low lubricating oil.

Referring to FIG. 6, it shows the second embodiment of the transmission apparatus. In the second embodiment, the blocking plate is an L-shaped plate including a first blocking plate 87 extending above the lead screw 6 and a second blocking plate 86 positioned at the other side of the lead screw 6 opposite to the rack 81. As a result, the blocking plate can block two directions of the splashed oil. The other elements in the drive are not contaminated by the splashed oil. The trenches 85 of the first and the second blocking plates 87, 86 are also used to store the splashed oil.

In addition, the blocking plate can be a [symbol] -shaped plate. The [symbol] -shaped blocking plate comprises a first blocking plate, a second blocking plate and a third blocking plate. The first and the second blocking plates are the same as the first and the second blocking plates of the L-shaped blocking plate of the second embodiment. The third blocking plate is extended from the second blocking plate and positioned under the lead screw 6 opposite to the first blocking plate. So the [symbol] -shaped blocking plate covers the lead screw and has a better blocking efficiency of the splashed oil. The trench is also on the first, second and the third blocking plate, respectively.

From the above description, the transmission apparatus comprises a blocking plate to block the splashed oil. As a consequence, the possibility of causing contaminated optical disk, and erroneous action of the reading and writing the disk will be minimized or eliminated.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical disk drive comprising:
an optical pickup for reading an optical disk;
a transmission apparatus comprising a rack, a connecting element and a connecting base, wherein the connecting element connects the rack with the connecting base and the connecting base is connected to the optical pickup;
a stepping motor connected to a lead screw, wherein the lead screw is meshed with the rack for moving the optical pickup and the lubricating oil is added between the rack and the lead screw;
wherein the transmission apparatus comprises a blocking plate connected to the connecting element and the blocking plate is extended above the lead screw for blocking the splashed oil.

2. The optical disk drive of claim 1, wherein the blocking plate comprises a trench for storing the splashed oil.

3. The optical disk drive of claim 1, wherein the blocking plate, the rack and the connecting element are integrated.

4. The optical disk drive of claim 1, wherein the length of the blocking plate is longer than the radius of the lead screw.

5. The optical disk drive of claim 1, wherein the blocking plate is an L-shaped plate and comprises a first blocking plate and a second blocking plate, wherein the first blocking plate is extended above the lead screw and the second plate is extended to the other side of the lead screw opposite to the rack.

6. The optical disk drive of claim 5, wherein the blocking plate is further comprises a third blocking plate connected to the second blocking plate, wherein the third blocking plate is extended under the lead screw opposite to the first blocking plate.
